(19) United States
(12) Patent Application Publication
(10) Pub. No.: US 2008/0238690 A1
(43) Pub. Date: Oct. 2, 2008

(54) DRIVER AND REGISTRATION IDENTIFICATION FOR VEHICLE ENABLEMENT

(75) Inventor: Laurence J. Plant, North Balwyn (AU)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/694,138

(22) Filed: Mar. 30, 2007

(51) Int. Cl. G07C 11/00

(52) U.S. Cl. 340/573.1

(57) ABSTRACT

A method and system are described for monitoring and enforcing license and operations restrictions on the operation of a motor vehicle. The method comprises the steps of uniquely identifying the operator of the vehicle, identifying driver license status and/or restrictions, and monitoring and enforcing the limits of operation of the vehicle. A preferred embodiment of the invention comprises (1) a means of uniquely identifying the driver identification based on techniques including but not limited to smartcard-based license and biometrics, at the outset of a journey and through the life of a journey; (2) a system for identifying driver license conditions (such as limits or suspension); and (3) a means, accessed by a vehicle, of continually identifying and authenticating the user, identifying license conditions and monitoring driver behavior (e.g., reporting the times and locations for journeys) or enforcing license conditions (e.g., preventing the vehicle from being started if the license has been suspended).

### BACKGROUND OF THE INVENTION

1. Field of the Invention

This invention generally relates to vehicle monitoring and control systems, and more particularly, to methods and systems to enforce driver specific license conditions and permissions specified by the vehicle owner.

2. Background Art

The motor vehicle has become an essential component of modem living. Many people own motor vehicles, many more use them, and virtually everyone relies, in one way or another, on the motor vehicle to provide the goods and services that are integral to a modem lifestyle.

Motor vehicles are used, for example, to transport people and goods from place to place in the ordinary course of daily commerce, such as to and from school, to and from work, and to and from stores, restaurants, and entertainment venues. In addition, motor vehicles are an essential part of emergency response procedures. Fire trucks are used to rush firemen and equipment to homes or buildings that are on fire, ambulances are used to rush people to hospitals and other medical facilities, and cars and vans may be used to rush police and other personnel to handle emergency situations. As is well understood, motor vehicles are in very common use and, in the vast majority of cases, are properly, safely, and appropriately used.

In order to help achieve this proper, safe and appropriate use, government's license motor vehicle drivers, and these licenses can be limited, suspended or taken away for a variety of reasons. There is, however, no effective means of enforcing limits to or suspensions of driver's licenses.

If someone has their driver's license suspended, they are still physically able to unlawfully operate a vehicle. If the police questions such a person while that person is in charge of a vehicle, detection of the suspended license can be avoided through presentation of false identification.

A driver may also have limits placed on their license. Such limits may include, for example, being able to drive only on specific routes, or only at specific speeds, or only specific classes of vehicles. Despite license limitations being in place, there is no automatic monitoring or enforcement of these limits, and drivers can (at the risk of being detected by authorities) operate a vehicle outside the limits associated with their drivers' licenses.

### SUMMARY OF THE INVENTION

An object of this invention is to effectively monitor and enforce driver license restrictions in order to improve motor vehicle safety.

Another object of the present invention is to enforce driver specific license conditions.

A further object of the invention is to link driver identification with policy and vehicle telematics to monitor and/or enforce license conditions.

These and other objectives are attained with a method of and system for monitoring and enforcing license and operations restrictions on the operation of a motor vehicle. The method comprises the steps of uniquely identifying the operator of the vehicle, identifying driver license status and/or restrictions, and monitoring and enforcing the limits of operation of the vehicle.

A preferred embodiment of the invention comprises (1) a means of uniquely identifying the driver identification based on techniques including but not limited to smartcard-based license and biometrics, at the outset of a journey and through the life of a journey; (2) a system for identifying driver license conditions (such as limits or suspension); and (3) a means, accessed by a vehicle, of continually identifying and authenticating the user, identifying license conditions and monitoring driver behavior (e.g., reporting the times and locations for journeys) or enforcing license conditions (e.g., preventing the vehicle from being started if the license has been suspended).

It should be noted that while the term “vehicle” includes cars and other road transport, the term could be extended to include, but not be limited to, any physical piece of equipment such as a forklift or industrial machine.

Further benefits and advantages of this invention will become apparent from a consideration of the following detailed description, given with reference to the accompanying drawing, which specifies and shows preferred embodiments of the invention.

### BREIF DESCRIPTION FO THE DRAWINGS

FIG. 1 diagrammatically depicts the present invention.

FIG. 2 shows components of the vehicle illustrated in FIG. 1.

### DETAILED DESCRIPTION OF THE PREFERRED EMBODIMENTS

The present invention, generally, provides a method and system for monitoring and enforcing license and operations restrictions on the operation of a motor vehicle. The method, generally, comprises the steps of uniquely identifying the operator of the vehicle, identifying driver license status and/or restrictions, and maintaining and enforcing the limits of operation of the vehicle.

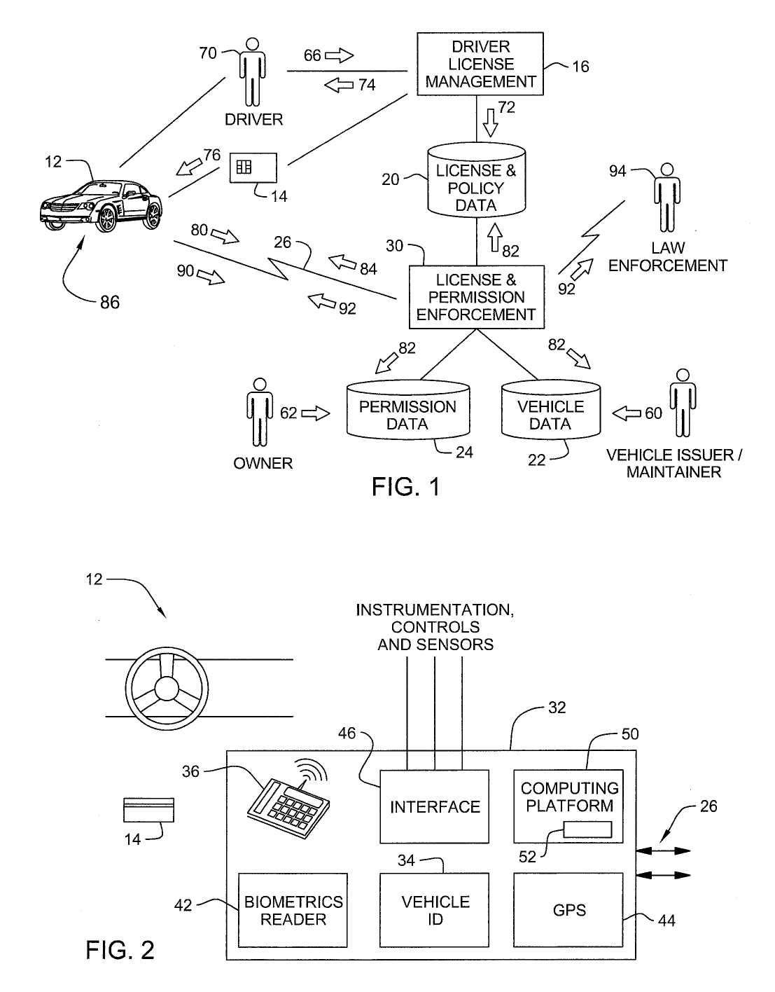

FIGS. 1 and 2 illustrate a preferred embodiment of the invention. The primary components of this embodiment comprise vehicle 12, smartcard 14, driver license management 16, license data repository 20, vehicle data 22, permission data 24, wireless communications links 26, and license and permission enforcement 30. Vehicle 12, in turn, includes telematics unit 32 including a vehicle ID 34, smartcard reader 36, communications links 26, biometrics reader 42, global positioning system 44, and interface 46 to vehicle instrumentation and controls. Interface 46 may interface with already existing data collection sources (speedometer, odometer, engine management systems, etc.) and with already existing vehicle or engine controls. In addition, vehicle 12 may be provided with a computing or processing platform 50 and with a software program, represented at 52, for use in the present invention.

Smartcard 14 holds driver information and driver ID. Driver License Management 16 is an administrative system to enable drivers to obtain a license and for license conditions to be established and modified over time. License Data Repository 20, which is held centrally, holds driver identification, license conditions and policy for handling violations of conditions.

As examples, license conditions may be that the driver is (a) able to drive only at certain times of day, (b) only able to drive certain classes of vehicles or specific vehicles, (c) only able to drive at certain places, or (d) only able to drive at certain speeds. A driver may also be limited to combinations of the above; and, another possible condition might be total suspension of a driver's license. As examples of policy data, a driver may be alerted of a minor violation of a condition, or law enforcement may be alerted of a major violation of a condition.

Vehicle data 22 includes, for instance, vehicle identification data and specifications of vehicles, such as engine size. Permission Data 24 identifies owners of vehicles, and maps licenses to vehicles as a means of identifying who has the right to use a vehicle and under what conditions. Permission Data 24, it may be noted, can be specific (by, for example, indicating that a particular vehicle or vehicles can only be used by specifically identified people) or implied (by, for instance, indicating that a particular vehicle or vehicles can be used by anyone except specifically identified people).

License and Permission Enforcement 30 is an operational platform that monitors drivers' access to and use of vehicles. This License and Permission Enforcement acts to notify interested parties (drivers, owners, law enforcement) of unapproved use of the vehicle, and acts to prevent or limit use of the vehicle, for example by setting a maximum speed or stopping the vehicle engine.

In the operation of the preferred embodiment of the invention, and as represented at step 60, vehicle identification and specifications are entered into the vehicle database 22. This can be done, for example, by the vehicle manufacturer, or by another authorized person or entity. Specification data could also be sourced from the vehicle telematics equipment. As represented at step 62, the vehicle owner 64 or another person with authority over the vehicle, creates and maintains permission data that identifies who can use the vehicle and under what conditions.

At step 66, a driver 70 applies for a license and supplies driver identifications. As represented at steps 72 and 74, the Driver License Management 16 establishes a license record for the driver, and issues smartcard 14 containing the driver's license.

When a driver attempts to use vehicle 12, the driver, as represented at step 76, supplies the smartcard, and, in particular, the smartcard is read by smartcard reader 36. Also, at step 80, Vehicle Telematics system 32 captures biometric and other data and passes this data with smartcard data to the License and Permission Enforcement system 30, seeking vehicle usage rules for this driver. The License and Permission Enforcement system 30, as represented at step 82, gathers current data and establishes vehicle usage rules for this driver and this vehicle at this time.

At step 84, vehicle usage rules are communicated to the vehicle. Vehicle Telematics system 32, as represented at step 86, monitors driver adherence to rules and/or as appropriate enforces the rules. At step 90, Event Data is fed to the License and Permission Enforcement system 30; and this License and Permission Enforcement system, at step 92, correlates events, checks rules, generates logs and optionally notifies law enforcement authorities, represented at 94.

The present invention may also be embodied in alternative architectures, which distribute data and logic to the vehicle. For example, an architecture may be used which enables the telematics unit in the vehicle to hold sufficient logic to enforce license conditions and to operate in an offline mode. For instance, the telematics unit may be enabled to operate in a disconnected mode of operation without an active link to a network server, and the telematics unit may be enabled to log data to a local device and card and periodically to synchronize with a host computer or network.

The preferred embodiment of the invention provides a number of important features for handling situations related to ongoing driver authentication, incremental permission, and expirations of permissions and conditions. Ongoing driver authentication is provided by implementing ongoing biometrics authentication of the driver as the vehicle is being used to prevent situations where vehicle control is passed from one party to another. Incremental permission is achieved by notifying a vehicle owner or other interested parties as vehicle or license conditions are approached or exceeded, in order to notify the owner and/or request permission on behalf of the driver for the vehicle to be continued to be operated.

The present invention also enables the expiration of permission and conditions such as time or event limits, for example. The invention enables the owner to set rules that specify that a user can continue to drive the vehicle until a specific data and time, or can continue to drive the vehicle until or unless they have exceeded the speed limit in any vehicle by, for instance, more than five km/hr three times in the last forty-eight hours.

In addition, sensors can be set and tested for compliance with vehicle or driver rules that require environmental or physiological data. For instance, sensors can be used to monitor compliance with a rule that the driver can carry only one passenger, or with a rule that the vehicle can only be driven by someone with zero blood alcohol content, or with a rule that a certain speed cannot be exceeded in wet conditions or after dark.

It may be noted that the present invention may be practiced with any vehicle where, for example, the operator is required to hold a valid license, such as a boat, a train, an aircraft, etc.

As will be readily apparent to those skilled in the art, the present invention, or aspects of the invention, can be realized in hardware, software, or a combination of hardware and software. Any kind of computer/server system(s)—or other apparatus adapted for carrying out tasks or procedures described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of tasks or procedures described herein, and which—when loaded in a computer system—is able to carry out these tasks or procedures. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of monitoring and enforcing license and operations restrictions on a motor vehicle, the method comprising the steps of:
entering vehicle identification and specification data into a vehicle database;
creating and maintaining permission data that identifies who can use the vehicle and under what conditions;
a driver applying for a driver's license and supplying information to a driver license management;
said driver license management establishing a license record for the driver and issuing to the driver a smartcard containing the driver's license for the driver;
said driver attempting to use the vehicle, including the steps of the driver inserting the smart card into a smart card reader, and the smartcard reader reading the smart card to obtain smartcard data therefrom;
a vehicle telematics system on the vehicle capturing biometric data and other data of the driver and environment and passing said biometric data and other driver and environmental data and said smartcard data to a license and permission enforcement system to obtain therefrom vehicle usage rules for the driver and the vehicle for the present time;
said license and permission enforcement system receiving said biometric data and said smartcard date, and establishing vehicle usage rules for the driver and the vehicle for the present time;
communicating said vehicle usage rules to the vehicle; and
a vehicle telematics system on the vehicle monitoring the driver's adherence to said vehicle usage rules, and enforcing said vehicle usage rules in accordance with a defined procedure.

2. A method according to claim 1, wherein the step of capturing biometric data includes the step of using said vehicle telematics system to implement ongoing biometric authentication of the driver as the vehicle is being used to prevent the driver from passing control of the vehicle to another person.

3. A method according to claim 2, wherein:
the vehicle identification and specification data are entered into the vehicle database by the manufacturer of the vehicle; and
the permissions data are created and maintained by the owner of the vehicle.

4. A method according to claim 3, comprising the further step of holding in a license data repository driver identification, license conditions and policy rules for handling violations of said license conditions.

5. A method according to claim 4, wherein said policy rules include alerting the driver of a first defined type of violations of said conditions, and alerting a law enforcement agency of a second defined type of violations of said conditions.
